(19) United States
(12) Patent Application Publication
(10) Pub. No.: US 2012/0026964 A1
(43) Pub. Date: Feb. 2, 2012

(54) SYSTEM AND METHOD FOR SIGNALING OF INTERFERING SPATIAL LAYERS WITH DEDICATED REFERENCE SIGNAL

(75) Inventors: Tommi Koivisto, Espoo (FI); Timo Roman, Espoo (FI); Mihai Enescu, Espoo (FI); Karol Schober, Helsinki (FI)

(73) Assignee: NOKIA CORPORATION, Espoo (FI)

(21) Appl. No.: 13/260,637

(22) PCT Filed: Mar. 26, 2010
(86) PCT No.: PCT/IB10/00691

§ 371 Date: Sep. 27, 2011

Related U.S. Application Data
(60) Provisional application No. 61/164,249, filed on Mar. 27, 2009.

(51) Int. Cl. H04W 72/04

(52) U.S. Cl. 370/329

(57) ABSTRACT

An apparatus, method and system for signaling of interfering spatial layers with dedicated reference signals in a communication system. In one embodiment, an apparatus includes a processor (520) and memory (550) including computer program code. The memory (550) and the computer program code are configured to, with the processor (520), cause the apparatus to receive an allocation of communication resources and a dedicated reference signal index for a spatial layer associated with the communication resources, receive information about spatial interference for a user equipment, and identify spatial interference with respect to at least one communication resource within the communication resources allocated to the user equipment in another spatial layer.

### TECHNICAL FIELD

The present invention is directed, in general, to communication systems and, in particular, to an apparatus, method and system for signaling of interfering spatial layers with precoded dedicated reference signals between a base station and user equipment for multi-user multiple input/multiple output support in a communication system.

### BACKGROUND

Long term evolution (“LTE”) of the Third Generation Partnership Project (“3GPP”), also referred to as 3GPP LTE, refers to research and development involving the 3GPP LTE Release 8 and beyond, which is the name generally used to describe an ongoing effort across the industry aimed at identifying technologies and capabilities that can improve systems such as the universal mobile telecommunication system (“UMTS”). The goals of this broadly based project include improving communication efficiency, lowering costs, improving services, making use of new spectrum opportunities, and achieving better integration with other open standards. The 3GPP LTE project produces new standards as well as standards recommendations for the UMTS.

The evolved universal terrestrial radio access network (“E-UTRAN”) in 3GPP includes base stations providing user plane (including packet data convergence protocol/radio link control/medium access control/physical (“PDCP/RLC/MAC/PHY”) sublayers) and control plane (including radio resource control (“RRC”) sublayer) protocol terminations towards wireless communication devices such as cellular telephones. A wireless communication device or terminal is generally known as user equipment (also referred to as “UE”). A base station is an entity of a communication network often referred to as a Node B or an NB. Particularly in the E-UTRAN, an “evolved” base station is referred to as an eNodeB. For details about the overall architecture of the E-UTRAN, see 3GPP Technical Specification (“TS”) 36.300 v8.7.0 (2008-12), which is incorporated herein by reference.

As wireless communication systems such as cellular telephone, satellite, and microwave communication systems become widely deployed and continue to attract a growing number of users, there is a pressing need to accommodate a large and variable number of communication devices transmitting a growing range of communication applications with fixed communication resources. The 3GPP is currently studying potential enhancements to the 3GPP LTE Release 8 to specify a new system called LTE-Advanced which is supposed to fulfill the International Mobile Telecommunications-Advanced (“IMT-Advanced”) requirements set by the International Telecommunications Union-Radiocommunication Sector (“ITU-R”). The topics that are included within the ongoing study item are bandwidth extensions beyond 20 megahertz (“MHz”), communication link relays, cooperative multiple input/multiple output (“MIMO”), uplink multiple access schemes, and MIMO enhancements. Regarding downlink MIMO transmission, the target with LTE-Advanced is to specify MIMO transmissions up to “8×8” (i.e., eight transmission antennas and up to eight receive antennas) allowing spatial multiplexing with up to eight spatial layers. The current 3GPP LTE Release 8 supports operation with only up to 4×4 downlink MIMO transmissions. Closed loop spatial multiplexing and spatial layers refer to controlling gain and phasing of a plurality of transmit and receive antennas to, for instance, improve a signal-to-interference ratio, maximize a user throughput measurement, or to null or otherwise attenuate an interfering signal.

An issue that needs to be resolved regarding MIMO techniques including, without limitation, cooperative MIMO and multi-user MIMO (also referred to as “MU-MIMO”), is the identification of dedicated reference signals associated with spatially multiplexed user equipment for channel estimation and subsequent data demodulation at the receiver thereof, as well as potential spatial interference suppression receiver processing. Recently, it has been agreed in the 3GPP Radio Access Network (“RAN”) Working Group 1 (“WG1”) that in a LTE-Advanced operation, dedicated (user equipment specific) precoded dedicated reference signals (also referred to as “DRSs”) are used for demodulation. This type of operation brings additional unresolved challenges to interference cancellation at the user equipment when MU-MIMO techniques are applied in either a single-cell or a multi-cell context.

In view of the growing deployment of communication systems such as cellular communication systems, it would be beneficial to provide signaling of a dedicated reference signal for spatial layer mapping (providing further dedicated reference signal information) by a base station to user equipment to enable interference cancellation at the user equipment. Therefore, what is needed in the art is a system and method that avoids the deficiencies of known communication systems for signaling of dedicated reference signal information to the user equipment with MU-MIMO or cooperative MIMO capability, and to enable interference cancellation.

### SUMMARY OF THE INVENTION

These and other problems are generally solved or circumvented, and technical advantages are generally achieved, by embodiments of the present invention, which include an apparatus, method and system for signaling of interfering spatial layers with dedicated reference signals in a communication system. In one embodiment, an apparatus includes a processor and memory including computer program code. The memory and the computer program code are configured to, with the processor, cause the apparatus to receive an allocation of communication resources and a dedicated reference signal index for a spatial layer associated with the communication resources, receive information about spatial interference for a user equipment, and identify spatial interference with respect to at least one communication resource within the communication resources allocated to the user equipment in another spatial layer.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the invention, and the advantages thereof, reference is now made to the following descriptions taken in conjunction with the accompanying drawings, in which:

FIGS. 1 and 2 illustrate system level diagrams of embodiments of communication systems including a base station and wireless communication devices that provide an environment for application of the principles of the present invention;

FIGS. 3 and 4 illustrate system level diagrams of embodiments of communication systems including a wireless communication systems that provide an environment for application of the principles of the present invention;

FIG. 5 illustrates a system level diagram of an embodiment of a communication element of a communication system for application of the principles of the present invention;

FIGS. 6 and 7 illustrate diagrams of exemplary dedicated reference signal patterns;

FIG. 8 illustrates a diagram of exemplary MU-MIMO allocations when up to four user equipment are multiplexed spatially on the same communication resources;

FIGS. 9 and 10 illustrate diagrams of exemplary multiplexing of user equipment on to spatial layers;

FIG. 11 illustrates a flow chart demonstrating an exemplary process to reduce interference between a plurality of user equipment employing MIMO operation on assigned spatial layers according to the principles of the present invention; and

FIG. 12 illustrates a flowchart demonstrating an exemplary process to reduce interference for user equipment employing MIMO operation with another user equipment that may share the same time-frequency communication resources according to the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. In view of the foregoing, the present invention will be described with respect to exemplary embodiments in a specific context of a system and method for signaling of dedicated reference signal (“DRS”) information in a downlink to a communication device such as user equipment with MU-MIMO capability to enable interference cancellation. The process is applicable, without limitation, to both single-cell MU-MIMO as well as cooperative MIMO.

In MU-MIMO operation, several users are scheduled on the same time/frequency communication resources and are multiplexed in the spatial domain so that multi-user interference is avoided as much as possible. This applies for both single-cell and multi-cell MU-MIMO operation, the latter also being known as collaborative/cooperative MIMO (“C-MIMO”) or coordinated multipoint transmission (“CoMP”). For example, in 3GPP LTE Release 8 MU-MIMO operation, the user equipment feeds back the optimum rank-1 precoding vector and, based thereon, the base station attempts to pair user equipment to limit interference therebetween.

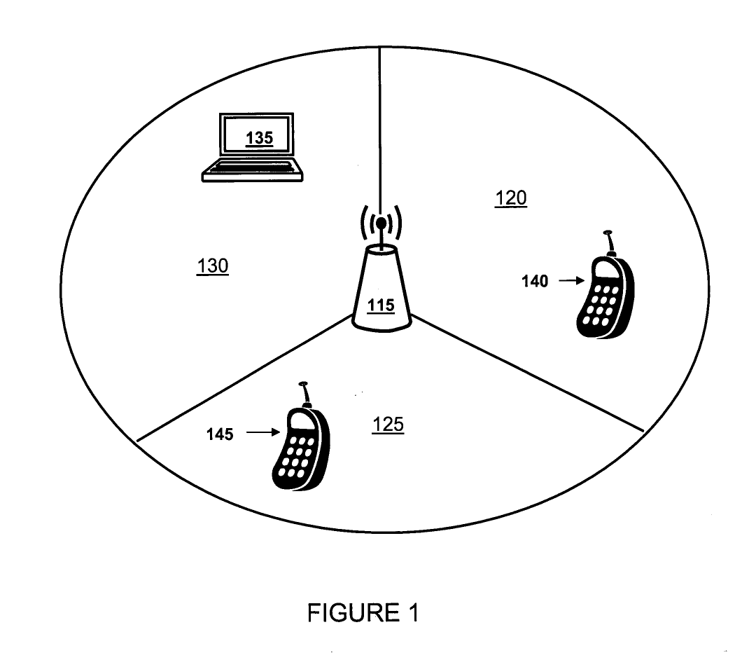

Turning now to FIG. 1, illustrated is a system level diagram of an embodiment of a communication system including a base station 115 and wireless communication devices (e.g., user equipment) 135, 140, 145 that provides an environment for application of the principles of the present invention. The base station 115 is coupled to a public switched telephone network (not shown). The base station 115 is configured with a plurality of antennas to transmit and receive signals in a plurality of sectors including a first sector 120, a second sector 125, and a third sector 130, each of which typically spans 120 degrees. Although FIG. 1 illustrates one wireless communication device (e.g., wireless communication device 140) in each sector (e.g. the first sector 120), a sector (e.g. the first sector 120) may generally contain a plurality of wireless communication devices. In an alternative embodiment, a base station 115 may be formed with only one sector (e.g. the first sector 120), and multiple base stations may be constructed to transmit according to C-MIMO operation, etc. The sectors (e.g. the first sector 120) are formed by focusing and phasing radiated signals from the base station antennas, and separate antennas may be employed per sector (e.g. the first sector 120). The plurality of sectors 120, 125, 130 increases the number of subscriber stations (e.g., the wireless communication devices 135, 140, 145) that can simultaneously communicate with the base station 115 without the need to increase the utilized bandwidth by reduction of interference that results from focusing and phasing base station antennas.

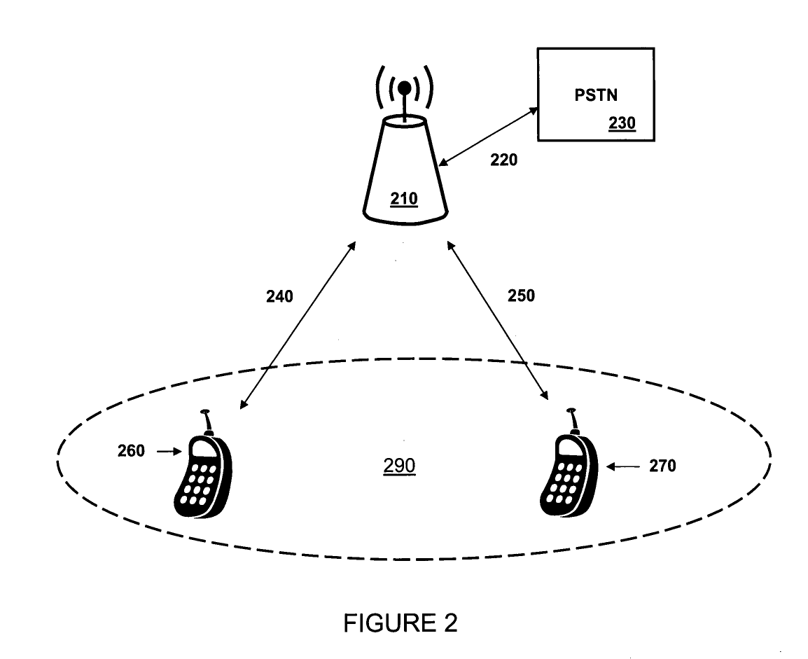

Turning now to FIG. 2, illustrated is a system level diagram of an embodiment of a communication system including wireless communication devices that provides an environment for application of the principles of the present invention. The communication system includes a base station 210 coupled by communication path or link 220 (e.g., by a fiber-optic communication path) to a core telecommunications network such as public switched telephone network (“PSTN”) 230. The base station 210 is coupled by wireless communication paths or links 240, 250 to wireless communication devices 260, 270, respectively, that lie within its cellular area 290.

In operation of the communication system illustrated in FIG. 2, the base station 210 communicates with each wireless communication device 260, 270 through control and data communication resources allocated by the base station 210 over the communication paths 240, 250, respectively. The control and data communication resources may include frequency and time-slot communication resources in frequency division duplex (“FDD”) and/or time division duplex (“TDD”) communication modes.

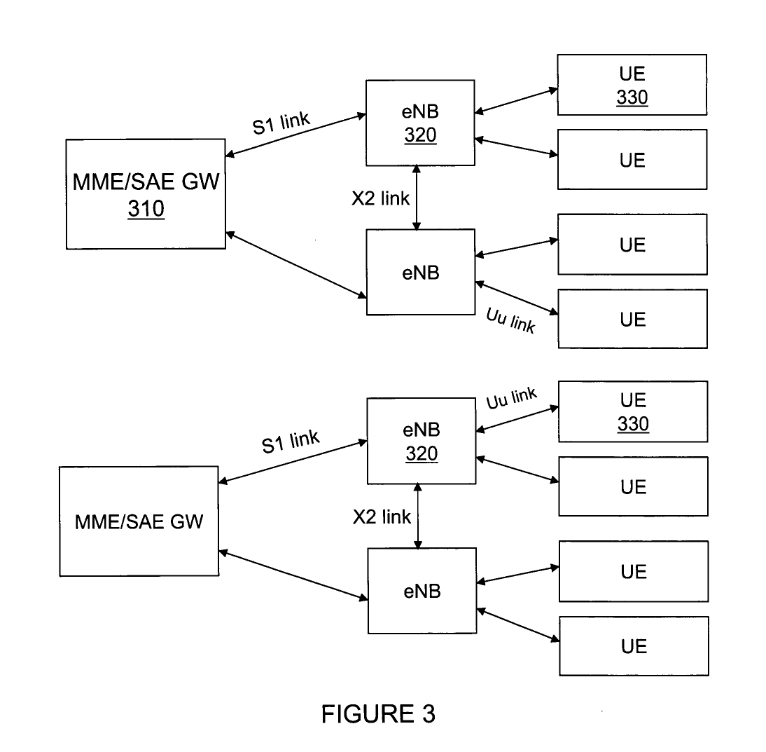

Turning now to FIG. 3, illustrated is a system level diagram of an embodiment of a communication system including a wireless communication system that provides an environment for the application of the principles of the present invention. The wireless communication system may be configured to provide evolved UMTS terrestrial radio access network (“E-UTRAN”) universal mobile telecommunications services. A mobile management entity/system architecture evolution gateway (“MME/SAE GW,” one of which is designated 310) provides control functionality for an E-UTRAN node B (designated “eNB,” an “evolved node B,” also referred to as a “base station,” one of which is designated 320) via an S1 communication link (ones of which are designated “S1 link”). The base stations 320 communicate via X2 communication links (ones of which are designated “X2 link”). The various communication links are typically fiber, microwave, or other high-frequency metallic communication paths such as coaxial links, or combinations thereof.

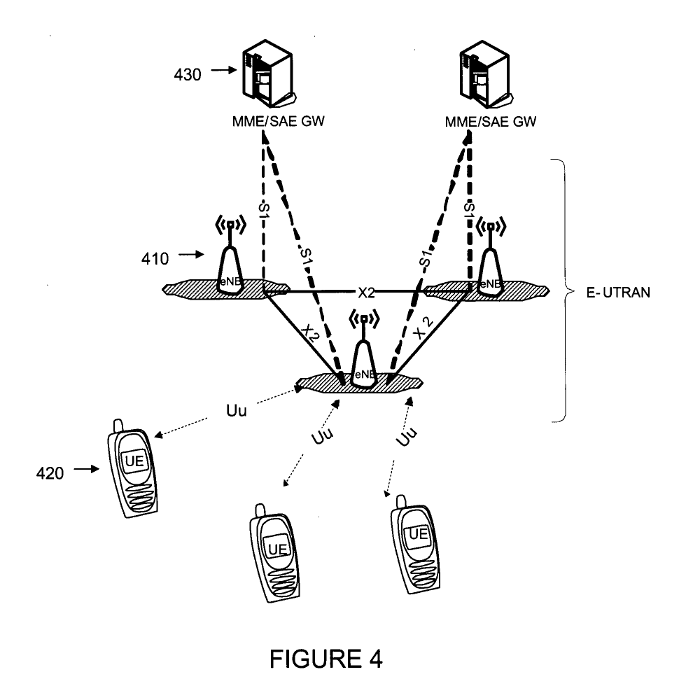

The base stations 320 communicate with user equipment (“UE,” ones of which are designated 330), which is typically a mobile transceiver carried by a user. Thus, communication links (designated “Uu” communication links, ones of which are designated “Uu link”) coupling the base stations 320 to the user equipment 330 are air links employing a wireless communication signal such as, for example, an orthogonal frequency division multiplex (“OFDM”) signal. Turning now to FIG. 4, illustrated is a system level diagram of an embodiment of a communication system including a wireless communication system that provides an environment for the application of the principles of the present invention. The wireless communication system provides an E-UTRAN architecture including base stations (one of which is designated 410) providing E-UTRAN user plane (packet data convergence protocol/radio link control/media access control/physical) and control plane (radio resource control) protocol terminations towards user equipment (one of which is designated 420). The base stations 410 are interconnected with X2 interfaces or communication links (designated “X2”). The base stations 410 are also connected by S1 interfaces or communication links (designated “S1”) to an evolved packet core (“EPC”) including a mobile management entity/system architecture evolution gateway (“MME/SAE GW,” one of which is designated 430). The S1 interface supports a multiple entity relationship between the mobile management entity/system architecture evolution gateway 430 and the base stations 410. For applications supporting inter-public land mobile handover, inter-eNB active mode mobility is supported by the mobile management entity/system architecture evolution gateway 430 relocation via the S1 interface.

The base stations 410 may host functions such as radio resource management. For instance, the base stations 410 may perform functions such as internet protocol (“IP”) header compression and encryption of user data streams, ciphering of user data streams, radio bearer control, radio admission control, connection mobility control, dynamic allocation of communication resources to user equipment in both the uplink and the downlink, selection of a mobility management entity at the user equipment attachment, routing of user plane data towards the user plane entity, scheduling and transmission of paging messages (originated from the mobility management entity), scheduling and transmission of broadcast information (originated from the mobility management entity or operations and maintenance), and measurement and reporting configuration for mobility and scheduling. The mobile management entity/system architecture evolution gateway 430 may host functions such as distribution of paging messages to the base stations 410, security control, termination of U-plane packets for paging reasons, switching of U-plane for support of the user equipment mobility, idle state mobility control, and system architecture evolution bearer control. The user equipment 420 receives an allocation of a group of information blocks from the base stations 410.

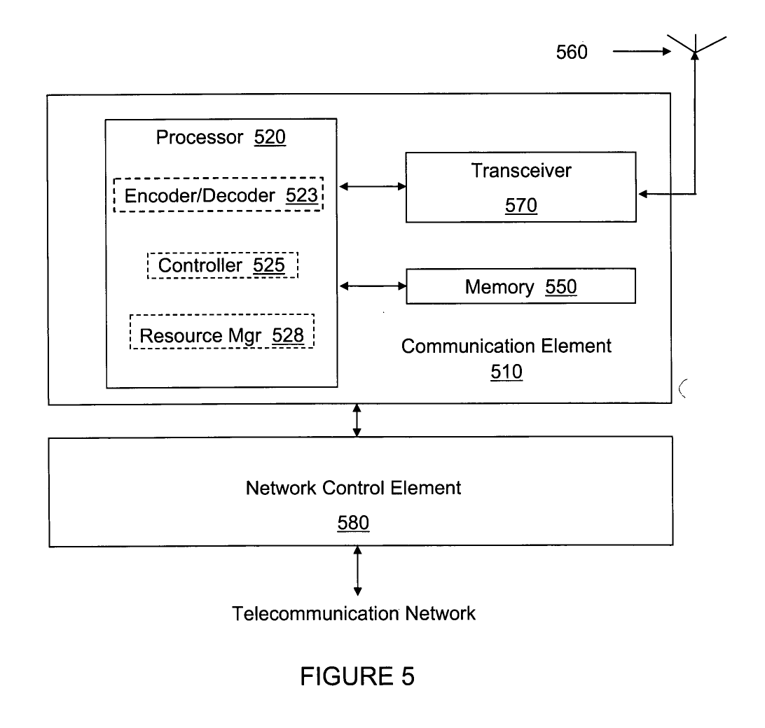

Turning now to FIG. 5, illustrated is a system level diagram of an embodiment of a communication element 510 of a communication system for application of the principles of the present invention. The communication element or device 510 may represent, without limitation, a base station, a wireless communication device (e.g., a subscriber station, terminal, mobile station, user equipment), a network control element, a communication node, or the like. The communication element 510 includes, at least, a processor 520, memory 550 that stores programs and data of a temporary or more permanent nature, an antenna 560, and a radio frequency transceiver 570 coupled to the antenna 560 and the processor 520 for bidirectional wireless communication. The communication element 510 may provide point-to-point and/or point-to-multipoint communication services.

The communication element 510, such as a base station in a cellular network, may be coupled to a communication network element, such as a network control element 580 of a public switched telecommunication network (“PSTN”). The network control element 580 may, in turn, be formed with a processor, memory, and other electronic elements (not shown). The network control element 580 generally provides access to a telecommunication network such as a PSTN. Access may be provided using fiber optic, coaxial, twisted pair, microwave communication, or similar link coupled to an appropriate link-terminating element. A communication element 510 formed as a wireless communication device is generally a self-contained device intended to be carried by an end user.

The processor 520 in the communication element 510, which may be implemented with one or a plurality of processing devices, performs functions associated with its operation including, without limitation, encoding and decoding (encoder/decoder 523) of individual bits forming a communication message, formatting of information, and overall control (controller 525) of the communication element, including processes related to management of communication resources (resource manager 528). Exemplary functions related to management of communication resources include, without limitation, hardware installation, traffic management, performance data analysis, tracking of end users and equipment, configuration management, end user administration, management of wireless communication devices, management of tariffs, subscriptions, security, billing and the like. For instance, in accordance with the memory 550, the resource manager 528 is configured to allocate time and frequency communication resources for transmission of data to/from the communication element 510 during, for instance, MU-MIMO modes of operation and format messages including the communication resources therefor.

The execution of all or portions of particular functions or processes related to management of communication resources may be performed in equipment separate from and/or coupled to the communication element 510, with the results of such functions or processes communicated for execution to the communication element 510. The processor 520 of the communication element 510 may be of any type suitable to the local application environment, and may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as non-limiting examples.

The transceiver 570 of the communication element 510 modulates information on to a carrier waveform for transmission by the communication element 510 via the antenna 560 to another communication element. The transceiver 570 demodulates information received via the antenna 560 for further processing by other communication elements. The transceiver 570 is capable of supporting duplex operation for the communication element 510.

The memory 550 of the communication element 510, as introduced above, may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. The programs stored in the memory 550 may include program instructions or computer program code that, when executed by an associated processor, enable the communication element 510 to perform tasks as described herein. Of course, the memory 550 may form a data buffer for data transmitted to and from the communication element 510. Exemplary embodiments of the system, subsystems, and modules as described herein may be implemented, at least in part, by computer software executable by processors of, for instance, the wireless communication device and the base station, or by hardware, or by combinations thereof. As will become more apparent, systems, subsystems and modules may be embodied in the communication element 510 as illustrated and described herein.

However, it is well known that base station-based interference cancellation is a challenge, and that additional interference cancellation at the wireless communication device (e.g., user equipment) is beneficial in terms of MU-MIMO performance. Interference cancellation often requires that the user equipment knows the effective channel corresponding to the interferer's precoding. In typical codebook-based systems, this can be done via signaling of the interferer's precoding vector to the user equipment with the user equipment's own precoding vector, as disclosed in U.S. patent application Ser. No. 61/148,449 entitled “Multiple User MIMO Communications System and Methods,” filed Jan. 30, 2009, and U.S. Patent Application Ser. No. 61/155,783 entitled “Multiple User MIMO Interference Suppression Communications System and Methods,” filed Feb. 26, 2009, which serve as priority documents for PCT Application Serial No. PCT/M2010/000157, filed Jan. 28, 2010, all of which are incorporated herein by reference.

As described previously, it has been proposed in the 3GPP RAN WGI that LTE-Advanced multi-antenna operation and, more precisely, spatial multiplexing will be based on precoded dedicated reference signals that are present in physical resource blocks (also referred to as “PRBs”) allocated to the user equipment, and are present for the spatial layers actually utilized in those PRBs. With dedicated reference signals, the precoding vectors need not to be transmitted. The precoding is “embedded” in reference signals (also referred to as “RSs”) by precoding the reference signals such that data and the reference signals undergo the same spatial precoding operation. The user equipment thus estimates the effective channel after precoding, and not the actual physical channel. In this case, the interferer's effective channel is not ascertained via signaling, but is estimated by the user equipment from the dedicated reference signals intended for the interferer.

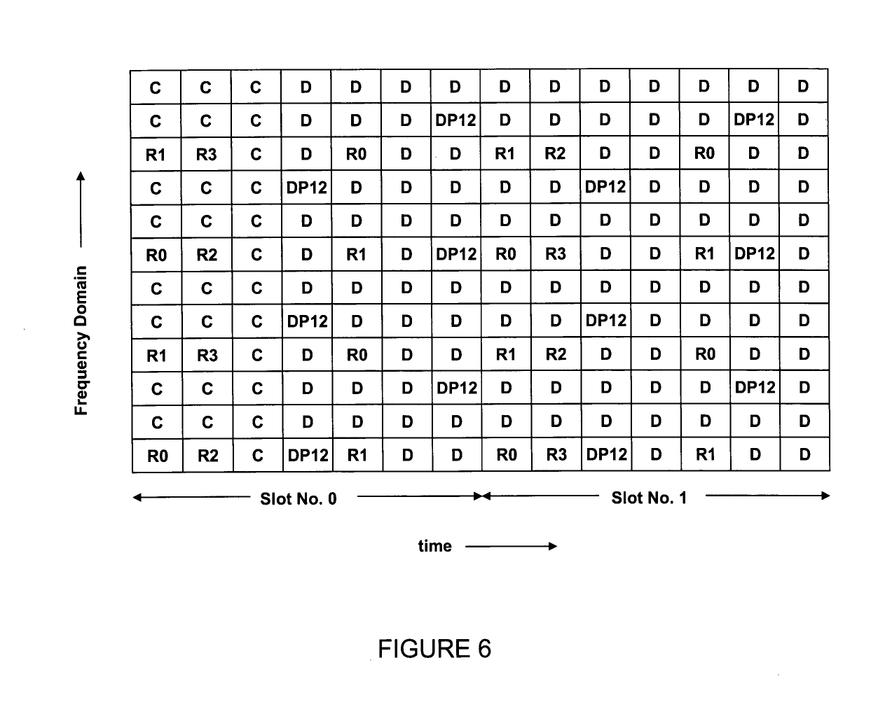

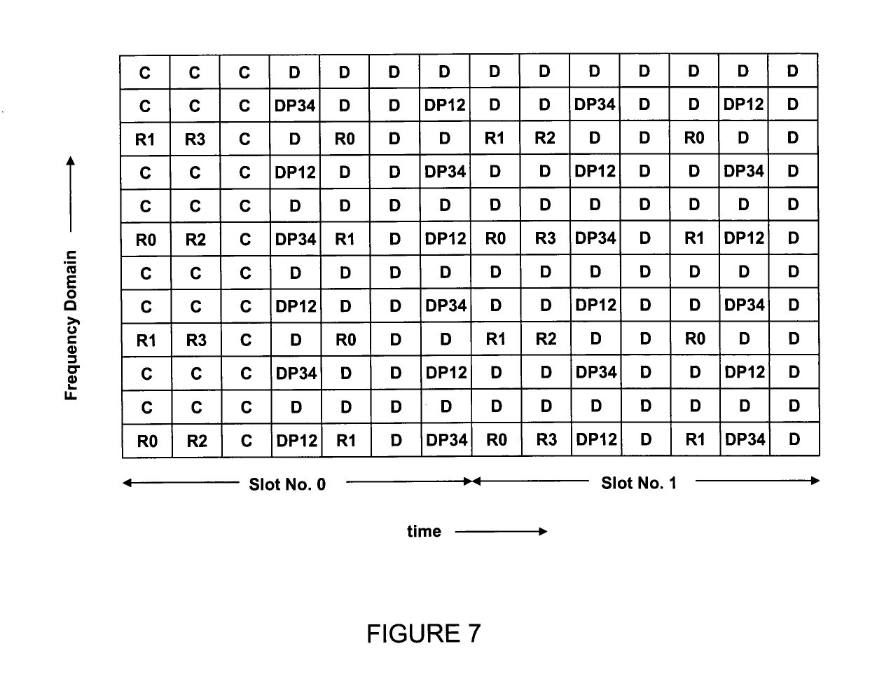

Turning now to FIGS. 6 and 7, illustrated are diagrams of exemplary dedicated reference signal patterns. Beginning with FIG. 6, the pattern is employed for multi-user purpose following the 3GPP LTE Release 8 dedicated reference signal design when up to two user equipment are multiplexed per physical resource block. In the illustrated embodiment, the dedicated reference signal for up to two spatially multiplexed user equipment would be code-multiplexed on a box labeled “DP12” employing code-division (or other type of) multiplexing. The spatially multiplexed user equipment may be separated using orthogonal codes, but it is noted that time division multiplexing (“TDM”)/frequency division multiplexing (“FDM”) type of dedicated reference signal multiplexing may also be also employed.

As illustrated in FIG. 6, a physical resource block includes 168 individual resource elements (“REs”). The vertical axis of the FIGURE represents frequency and the horizontal axis represents time. The resource elements are grouped into orthogonal frequency division multiplex (“OFDM”) symbols, shown as the vertical columns of the physical resource blocks. Each resource element includes one subcarrier of an OFDM symbol. Seven OFDM symbols are grouped into a time slot such as Slot No. 0 and Slot No. 1 (assuming a normal cyclic prefix length). A physical resource block including 12 subcarriers over the two slots is illustrated in FIG. 6 (i.e., a total of 168 resource elements in this example). The system bandwidth spans a total of N physical resource blocks, which form one downlink subframe.

The symbols “C” in the physical resource blocks represent control data, and the symbols “D” represent information data. The symbols R0, R1, etc., represent common reference signals available at an antenna port of a base station transmitted at the cell level over the full frequency band in every subframe. These common reference signals are transmitted without spatial precoding to all user equipment in the coverage area of a base station.

The symbol “DP12” represents dedicated reference or pilot signals corresponding to a spatial layer allocated to a particular user equipment, and transmitted with communication resources allocated and spatially precoded for that user equipment. The symbol “DP12” represents dedicated reference signals No. 1 and No. 2, each of these corresponding to a different spatial layer allocated to two different user equipment. The dedicated reference signals No. 1 and No. 2 are code division multiplexed. Of course, such an arrangement can be applied to more than two user equipment employing code division multiplexing with appropriate code length.

In the example illustrated in FIG. 6, there are two, spatially multiplexed user equipment. The first user equipment is assigned code number 1 to enable it to process the respective dedicated reference signal boxes, which enables the user equipment to estimate its equivalent channel and the respective modulated data. The other user equipment is signaled separately. The other user equipment uses code number 2, which enables the second user equipment to process its respective channel. Assignment of a code number is a process that may be performed at a base station after scheduling. The base station would assign each user equipment a certain code, and signal the assignment on the control channel.

Regarding FIG. 7, illustrated is an example similar to that illustrated in FIG. 6 for the case of multiplexing up to four user equipment, or two user equipment each communicating over two streams. FIG. 7 illustrates an exemplary dedicated reference signal pattern for multi-user purpose, again following the 3GPP LTE Release 8 dedicated reference signal design. In this example, the dedicated reference signals for up to four user equipment would be code-multiplexed on DP12 and DP34 positions. Two of the user equipment share dedicated reference signals No. 1 and No. 2, as indicated by DP12, and two of the user equipment share No. 3 and No. 4, as indicated by DP34. The symbols DP12 and DP34 can also be used by two user equipment, each being scheduled two streams. The four dedicated reference signal sets may be multiplexed via, for instance, code division multiplexing (“CDM”)/time division multiplexing (“TDM”)/frequency division multiplexing (“FDM”) or in a combination thereof.

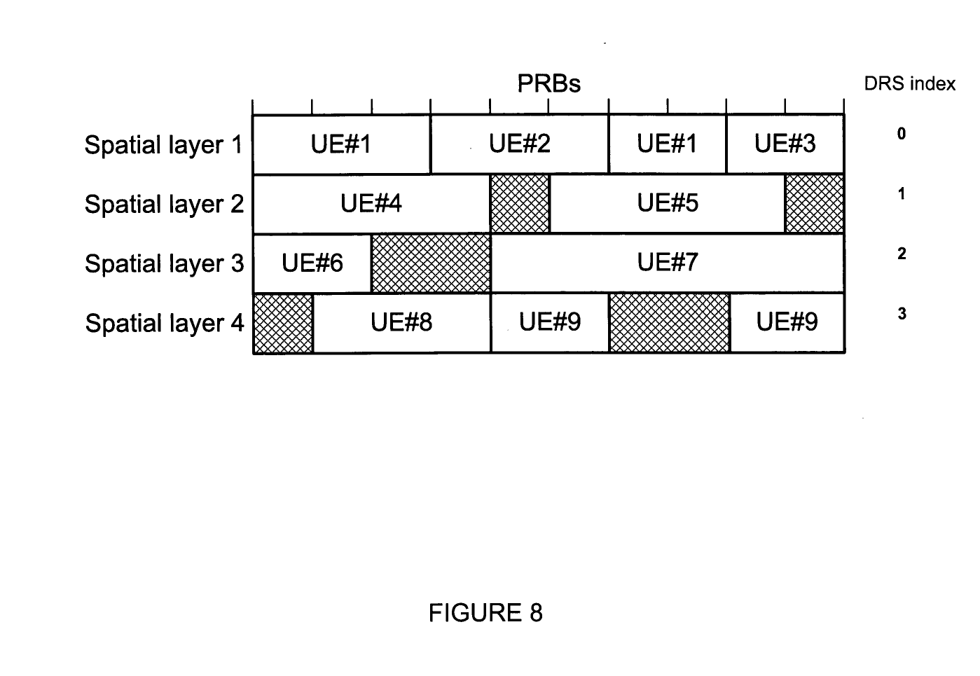

Turning now to FIG. 8, illustrated is a diagram of exemplary MU-MIMO allocations when up to four user equipment are multiplexed spatially on the same communication resources such as the physical resource blocks. The FIGURE illustrates assignment of user equipment to particular spatial layers and physical resource blocks. Hashing in the FIGURE represents no user equipment scheduled on the particular physical resource block and spatial layer. Multiplexing on the same physical resource block resources means the assigned user equipment occupy the same communication resources in frequency and time, and these physical resource block resources are distinguished by antenna pre-coding (“antenna weight set”) at the base station. The antenna weight set, which is selected to be orthogonal from other antenna weight sets, is used by the base station for each user equipment/spatial layer to modulate the data for the particular user equipment/spatial layer. An antenna weight set forms a “beam” for each user equipment/spatial layer. An antenna weight set may be constructed to be orthogonal or substantially orthogonal to a channel of other user equipment. A number N of physically separated antennas at a base station may enable the formation of N beams. Alternatively, non-unitary (e.g., zero-forcing) precoding can be employed that diagonalizes the equivalent channel for each of the user equipment.

As illustrated in FIG. 8, in spatial layer 1, the first, second and third user equipment UE #1, UE #2, UE #3 may all operate on the same spatial layer with proper spatial precoding (user equipment- and possibly frequency-dependent spatial precoded), such that interference on other spatial layers (spatial layers 2, 3, 4 in this example) is avoided as much as possible. The first user equipment UE #1 occupies five physical resource blocks in spatial layer 1 (i.e., UE #1 is allocated 5×12=60 subcarriers in frequencies across the subframe). Recall that a physical resource block is typically formed of 14 OFDM symbols, and each OFDM symbol typically includes 12 subcarriers. The fourth and fifth user equipment UE #4, UE #5 may operate in spatial layer 2 with proper spatial precoding such that interference on other spatial layers (spatial layers 1, 3, and 4 in this example) is avoided as much as possible. As evident in FIG. 8, user equipment communication resource allocations in terms of physical resource blocks can be different due to frequency domain scheduling.

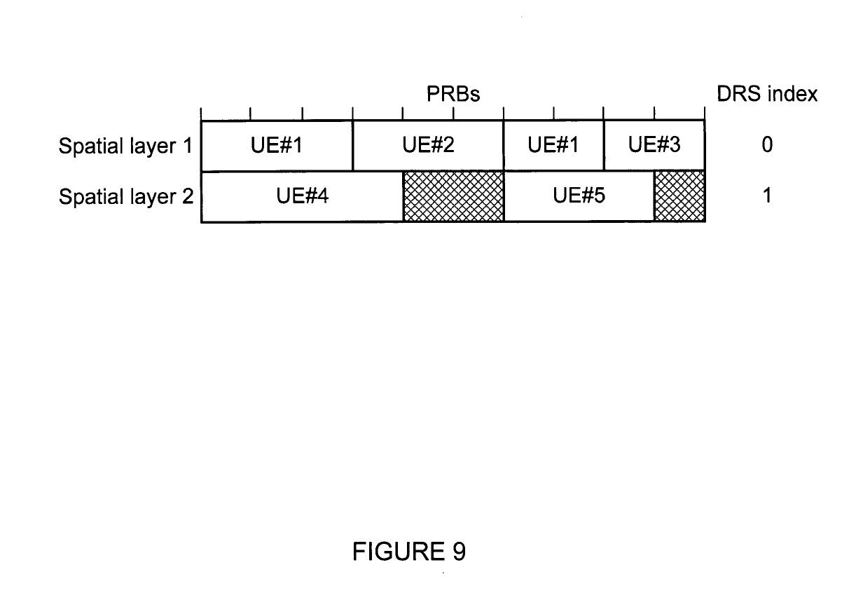

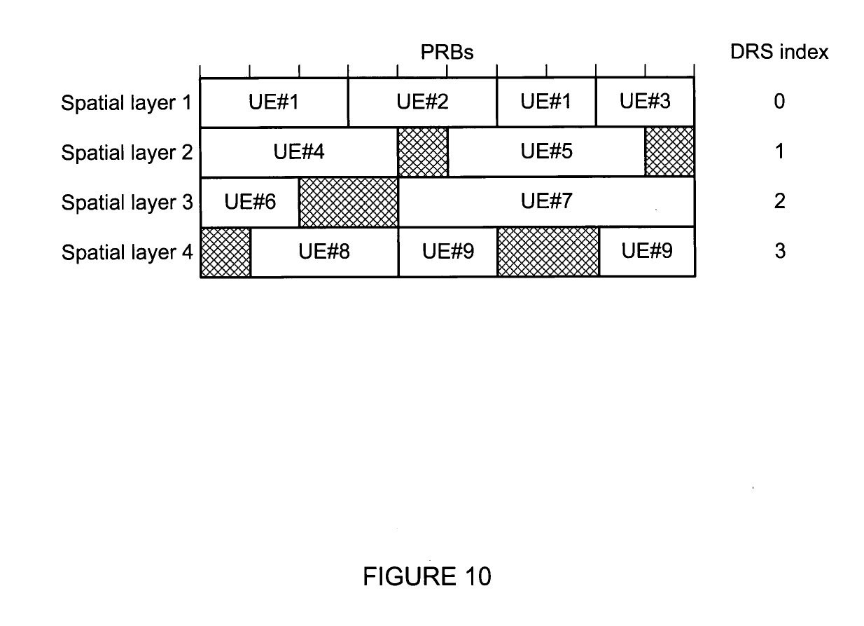

Turning now to FIGS. 9 and 10, illustrated are diagrams of exemplary multiplexing of user equipment on to spatial layers. Beginning with FIG. 9, illustrated is an exemplary multiplexing of user equipment onto two spatial layers, wherein a dedicated reference signal set with index 0 is allocated to the user equipment on the first spatial layer, and a dedicated reference signal set with index 1 is allocated to user equipment on the second spatial layer. The dedicated reference signal set with index 0 is allocated to the first, second and third user equipment UE #1, UE #2, UE #3 on the first spatial layer, and the dedicated reference signal set with index 1 is allocated to the fourth and fifth user equipment UE #4, UE #5 on the second spatial layer.

The dedicated reference signal index indicates to the user equipment on spatial layer 1 that they will use the dedicated reference signal index 0 (e.g., employing code division multiplexing with code index 0), and the user equipment on spatial layer 2 that they will use dedicated reference signal index 1 (e.g., employing code division multiplexing with code index 1). For example, the dedicated reference signal index 0 in FIG. 9 may refer to the first dedicated reference signal represented by the “No. 1” of symbol “DP12” in FIG. 6, and dedicated reference signal index 1 may refer to the second dedicated reference signal represented by the “No. 2” of symbol “DP12” in FIG. 6. Thus, the data received by the user equipment on spatial layer 1 would be demodulated with the dedicated reference signal represented in FIG. 6 by the “No. 1” of symbol “DP12,” and the data received by the user equipment on spatial layer 2 would be demodulated with the dedicated reference signal represented in FIG. 6 by the “No. 2” of symbol “DP12.” The dedicated reference signal index now transmitted to the user equipment enables the respective user equipment to estimate the equivalent channel corresponding to their own spatially precoded signals (i.e., the ones intended for that particular user equipment), and to equalize and demodulate the desired information signal. Similarly, for spatial multiplexing of up to four user equipment, the dedicated reference signal index with values 0, 1, 2, and 3, is illustrated in FIG. 10 to indicate to the user equipment on the respective spatial layer 1, 2, 3, or 4 that received data would be demodulated with dedicated reference signal as represented in FIG. 7 by symbols “DP12” and “DP34.” Of course, alternative dedicated reference signal correspondences can be constructed. This illustrates an operational issue for the user equipment. Each user equipment is informed of its own communication resource allocation and dedicated reference signal index via downlink control signaling and, hence, cannot be aware of which physical resource blocks are in use by other user equipment on other spatial layers. It is noted that the dedicated reference signals are sent on the scheduled physical resource blocks per spatial layer. Hence, the user equipment estimating an interferer's effective channel for interference cancellation cannot possibly know whether the interferer and the corresponding dedicated reference signal are present on other spatial layers in certain physical resource blocks. Thus, there is a need for a process to inform the user equipment, with reasonable overhead, about communication resource allocation on other spatial layers so that the user equipment can reliably estimate interference. Full scheduling flexibility should be maintained in frequency domain scheduling. It is desirable, for example, not to restrict the physical resource block allocation by the base station for each user equipment to be the same.

A signaling process for communicating information about interfering spatially multiplexed user equipment communication resource allocation from a base station to a user equipment is not presently known. A possible solution to the problem of communicating a precoded dedicated reference signal to user equipment for interfering spatially multiplexed user equipment would be for the base station to signal the precoded dedicated reference signal to the user equipment with an interferer's full communication resource allocation. This may introduce a heavy (downlink) signaling overhead. However, in this case, scheduling flexibility for the base station is still restricted since the physical resource block allocation of the spatially multiplexed user equipment is forced to be the same.

Another possible solution is to employ blind detection by user equipment of the presence of interferers (e.g., other user equipment). This can be done by a user equipment by, for instance, correlating the known interferer's dedicated reference signals with the received signal, and comparing the correlation result with a threshold. If the threshold is exceeded, an interferer is determined to be present on the corresponding spatial layer in the particular physical resource block and, thus, can be cancelled by the user equipment. For instance, the user equipment may cancel the interference by employing a certain set of receive antenna weights, or more generally with appropriate spatial interference suppression processing, provided that the user equipment has remaining spatial degrees of freedom to perform such interference cancellation. Such a process requires that the user equipment have several receiving antennas. This approach, however, introduces additional complexity, since the user equipment employs blind detection separately for each physical resource block unless scheduling restrictions are introduced. Utilization of user equipment communication resources could be degraded because an interference cancellation operation could be falsely performed even when no interferer is present. This type of blind detection can be expected to be quite unreliable and processing communication resource expensive.

A third possible solution is to let the user equipment always estimate interference, even if there is no interference present in some physical resource blocks on other spatial layers. In this case, the user equipment would estimate noise in the physical resource blocks in which there is no interferer and, hence, may include equalizer coefficients based on an incorrect estimation result (i.e., based on noise). This, too, would potentially lead to performance degradation and expenditure of unnecessary communication resources.

A signaling process is introduced herein to provide information to the user equipment about communication resource allocation on other spatial layers, and to enable utilization of interfering user equipment precoded dedicated reference signals for interference estimation. This allows a user equipment to reliably estimate the effective channel of the interferer, and to cancel multi-user interference with reasonable (e.g., minimal) communication resource expenditure. Full base station scheduling flexibility regarding allocation of communication resources to user equipment can be maintained.

As introduced herein, the interfering user equipment precoded dedicated reference signal set (e.g., an index) is signaled by a base station to a user equipment (e.g., in the physical downlink control channel (“PDCCH”), and signal indicator bit(s), possibly per spatial layer, indicate to the user equipment whether the spatial layers corresponding to the interfering user equipment precoded dedicated reference signals are utilized in the physical resource blocks corresponding to the user equipment's own communication resource allocation. If this is the case, a user equipment, knowing that multi-user interference is present in the allocated physical resource blocks on a given spatial layer, may estimate interference on that spatial layer and reliably cancel the same (e.g., by local selection of an antenna weight set). If not, the user equipment will not attempt to cancel the interference, and the base station, may, for example, lower the modulation coding scheme (“MCS”) used for transmitting to the user equipment, if needed, to increase a signal-to-interference ratio at the user equipment. A decision to transmit signal indicator bit(s) is dependent on the base station implementation, which may balance possible signal detection losses at a user equipment if it is determined that interfering spatial layers are present, perhaps in a majority of physical resource blocks, but not necessarily in every physical resource block.

Since it is necessary to signal a user equipment's own precoded dedicated reference signal positions to each user equipment (i.e., the dedicated reference signal which the user equipment uses for its own data demodulation), one method of signaling an interfering user equipment's precoded dedicated reference signal would be to link it implicitly to the user equipment's own precoded dedicated reference signal (i.e., no explicit signaling of the interfering user equipment dedicated reference signal is needed). In this case, only the interference indicator bit(s) would be signaled, keeping the overhead to a few bits, or even a single bit. For an example to illustrate implicit linking, a first user equipment may have dedicated reference signal index 0. Accordingly, the other user equipment should have a dedicated reference signal index 1, if only two spatial layers are in use, and there is no need to signal the dedicated reference signal index of the other user equipment. In another example, if there are four spatial layers and two streams (layers) per user equipment for two user equipment, then the first user equipment may have dedicated reference signal indices 0 and 1, and the other user equipment should have dedicated reference signal indices 2 and 3. For two user equipment, if the interference bit is set to 1 for the first user equipment, then it knows that spatial interference can be estimated within its allocated communication resources from dedicated reference signal indices 2 and 3.

As in some cases, a user equipment may lack a sufficient number of receive antennas (degrees of freedom) for cancelling all interfering user equipment, the base station may signal to the user equipment an index identifying the spatial layer that the user equipment should cancel. This also indicates that the particular signaled spatial layer is fully occupied in all physical resource blocks corresponding to the user equipment's own communication resource allocation. If multiple, interfering spatial layers are present, the indicator bits could be logically AND'd (i.e., bundled) together. Then, an interference bit set to one user equipment would indicate that all spatial layers are fully occupied within the user equipment's communication resource allocation, and the user equipment would pick the one(s) to be cancelled in some implementation-specific manner (e.g., by detecting, comparing, and sorting the worst interferers (other user equipment)).

The actual precoded dedicated reference signals may be signaled to a user equipment by multiplexing in an arbitrary manner. Typically, user equipment could be separated (i.e., rendered non-interfering) using different codes if their dedicated reference signals overlap in time and frequency (e.g., if the communication arrangement employs code division multiplexing), or the user equipment could be separated by transmitting their dedicated reference signals on different time and frequency communication resources (e.g., when time division multiplexing/frequency division multiplexing is employed). In addition, hybrid TDM/FDM/CDM methods for dedicated reference signal multiplexing may be included in the process.

The dedicated reference signal and interference signaling process introduced herein and described by examples is operable over a range of scenarios. A person skilled in the art of cellular system communication design will understand that the signaling arrangement introduced herein need not be limited to the described or exemplary cases. Several exemplary scenarios are now described to provide further examples of spatial multiplexing with efficient interference signaling. In certain cases, a higher spatial multiplexing order may be employed than that illustrated in these examples.

In a first exemplary scenario, up to two user equipment are spatially multiplexed. The first scenario is a typical case of two spatial layers and two multiplexed user equipment, each with one communication stream. This is the most likely case in practice, and is independent of the number of antennas at the base station. It is noted that the signaling process introduced herein is not limited to such a case. A greater number of user equipment could be spatially multiplexed on one communication resource, especially for C-MIMO operation. FIG. 9 illustrates a particular example of this case. A dedicated reference signal is allocated with index 0 to user equipment on a first spatial layer, and a dedicated reference signal with index 1 is allocated to user equipment on another spatial layer. The two dedicated reference signal sets could be code multiplexed. In this example, some parts of the second spatial layer may be left unscheduled. The user equipment typically has at least two receive antennas. Hence, there are sufficient degrees of freedom for the user equipment to cancel up to one spatial interferer (e.g., other user equipment) by selection of an antenna weighting set (i.e., by antenna amplitude and phase control).

In this case, both user equipment are signaled with the dedicated reference signal index used for their transmission, or which spatial layer is used in the case where there is a one-to-one mapping between the spatial layer and the dedicated reference signal. The user equipment then implicitly knows which spatial layer and dedicated reference signal is to be treated as interference. Then, one bit is signaled indicating whether the spatial layer corresponding to the interfering user equipment is used over the full allocation of physical resource blocks to the user equipment. Table 1 shows an example of signaling in this case.

TABLE 1
Proposed signaling in the example of FIG. 9

| | DRS bit | Interference bit |
|---|---|---|
| UE#1 | 0 | 1 |
| UE#2 | 0 | 0 |
| UE#3 | 0 | 0 |
| UE#4 | 1 | 1 |
| UE#5 | 1 | 1 |

As a first example, consider the fourth user equipment UE #4 in Table 1. This user equipment is signaled to employ dedicated reference signal set 1 (as indicated by the 1 in the middle column of Table 1) for demodulating its own transmission. The interference bit is also equal to 1, indicating that interference may be present in all its allocated physical resource blocks. Hence, the fourth user equipment UE #4 implicitly knows in principle (by “elimination”) that any potential interfering user equipment would be using the other dedicated reference signal set (i.e., DRS set 0). Thus, the dedicated reference signal set 0 should be utilized by the user equipment for estimating interference. The interference can thus be reliably estimated by a user equipment and cancelled. Note that it is left up to the user equipment whether or not to cancel that interference.

As another example, consider the second user equipment UE #2 in Table 1. The dedicated reference signal set for demodulation is set to 0, and hence, again by elimination, interfering user equipment uses the dedicated reference signal set 1. However, spatial layer 2 is not fully occupied over the physical resource block allocation of the second user equipment UE #2. From FIG. 9, it can be observed that the second user equipment UE #2 has three physical resource blocks on spatial layer 1. In the corresponding physical resource blocks on spatial layer 2, there is a “hole” in the allocation (i.e., interference is not present in all physical resource blocks). In this case, a “0” can be signaled in the interference bit to indicate “no interference,” even if interference is actually present in one physical resource block. Hence, as introduced herein, the most harmful interference cases can be signaled when interference is present in all allocated physical resource blocks. Thus, the interference bit is set to 0 by the base station. In this case, the user equipment does not even attempt to cancel interference, but, rather, the base station may decide to reduce the modulation coding scheme to improve communication reliability. Note that in this particular example any multi-user interference would probably be minor anyway, since there is an overlap of only one physical resource block between the user equipment. Note also that without the interference bit, either a user equipment is not able to perform any interference cancellation, or a user equipment would need to detect the existence of interference separately for each physical resource block, which, as explained earlier, may lead to technical challenges (i.e., detection of the presence of spatial interference) and possibly performance degradations (in the case where interference cancellation is being performed without actual presence of any spatial interference).

A way to extend the process of communicating dedicated reference signals as introduced herein to multiple interfering spatial layers is to signal one bit per each spatial layer. Table 2, with reference to FIG. 10, illustrates an example of such signaling, wherein an interference bit is associated with each of three spatial layers. Note that once the user equipment is informed of its own dedicated reference signal index, there is an implicit mapping between the interference bits and the corresponding spatial layer. For example, the fifth user equipment UE #5 in Table 2 has a dedicated reference signal set 1. Hence, interference bit 1 would correspond to dedicated reference signal set 0, interference bit 2 would correspond to dedicated reference signal set 2, and interference bit 3 would correspond to dedicated reference signal set 3.

TABLE 2
An example of DRS signaling for the example illustrated in FIG. 10

| | Own DRS | Interference | Interference | |
|---|---|---|---|---|
| | (2 bits needed) | bit 1 | bit 2 | Interference bit 3 |
| UE#1 | 0 | 1 | 0 | 0 |
| UE#2 | 0 | 0 | 0 | 1 |
| UE#3 | 0 | 0 | 1 | 1 |
| UE#4 | 1 | 1 | 0 | 0 |
| UE#5 | 1 | 1 | 1 | 0 |
| UE#6 | 2 | 1 | 1 | 0 |
| UE#7 | 2 | 1 | 0 | 0 |
| UE#8 | 3 | 1 | 1 | 0 |
| UE#9 | 3 | 1 | 0 | 1 |

For example, consider the seventh user equipment UE #7 in Table 2. Only the first spatial layer is fully occupied in all allocated physical resource blocks as seen from FIG. 10 and, hence, it is probably also the one causing the worst interference. Hence, the interference bits indicate that the seventh user equipment UE #7 should attempt interference cancellation using dedicated reference signal set 0, whereas its own dedicated reference signal set is 2.

A further alternative as introduced herein is for the base station to signal the index of the spatial layer that the user equipment should attempt to cancel. One value can be reserved for indicating by a base station to the user equipment that nothing can or should be cancelled. This idea is particularly useful in cases where the user equipment does not have a sufficient number of receive antennas to cancel all interferers, since the base station can then direct the user equipment to cancel out the spatial layer that is expected to cause the worst interference. This approach is appealing in terms of low overall downlink control overhead, since most user equipment will practically be able to cancel a single interferer (other user equipment). This may also be advantageous when four user equipment are multiplexed, a user equipment may not be able to cancel all interferers due to lack of degrees of freedom of its receiving antenna. A typical number of receive antennas for user equipment is two.

TABLE 3
An example of an index signaling approach corresponding to FIG. 8

| | Own layer/DRS (2 bits) | Layer/DRS to be cancelled (2 bits) |
|---|---|---|
| UE#1 | 0 | 1 |
| UE#2 | 0 | 3 |
| UE#3 | 0 | 2 |
| UE#4 | 1 | 0 |
| UE#5 | 1 | 2 |
| UE#6 | 2 | 0 |
| UE#7 | 2 | 0 |
| UE#8 | 3 | 0 |
| UE#9 | 3 | 0 |

Consider the fifth user equipment UE #5 in Table 3 as an example. There are two spatial layers (0 and 2) in which an interfering user equipment is scheduled on all physical resource blocks allocated to the fifth user equipment UE #5. Note that indices 0 and 2 correspond with the dedicated reference signal indices, but the corresponding spatial layer indices would be 1 and 3. As illustrated in FIG. 8, the fifth user equipment UE #5 is on spatial layer 2. On spatial layer 1, all physical resource blocks corresponding to the fifth user equipment UE #5 physical resource block allocation are occupied. The same applies to spatial layer 3. However, on spatial layer 4 there are again holes in the physical resource blocks. The fifth user equipment UE #5 does not suffer from interference caused by spatial layer 4. However, the fifth user equipment UE #5 has only two receiving antennas and, hence, is able to cancel out only one interferer. From precoding, the base station may possibly determine that spatial layer 3 will cause worse interference than spatial layer 1, and hence indicate this to the fifth user equipment UE #5 that will then attempt to cancel spatial layer 3 using the corresponding dedicated reference signal. Note that one way to signal that no spatial layers need to (or can) be cancelled is to signal the same spatial layer as the user equipment's own spatial layer with the interference bits.

One process according to an embodiment applies the logical AND operator per user equipment to the interference bits of Table 2, leading to smaller overhead of only one bit per user equipment. This may not be a good option, since it is likely that the logical AND operation will cause the interference bit to be 0 almost all the time. It is equal to 1 only when all interfering spatial layers are fully occupied by other user equipment.

A further exemplary case is when the user equipment is receiving a two stream transmission and is still spatially multiplexed with other user equipment. Clearly, the mechanisms outlined above are also applicable here (i.e., the base station can still indicate the most suitable spatial layer to be cancelled when the spatial layer is utilized on all physical resource blocks allocated to the user equipment. A difference is in signaling of the dedicated reference signal since now two sets of dedicated reference signals (one per stream) are signaled to the user equipment. Hence, there may also be some difference in the implicit mapping of a user equipment's own dedicated reference signal to an interfering dedicated reference signal.

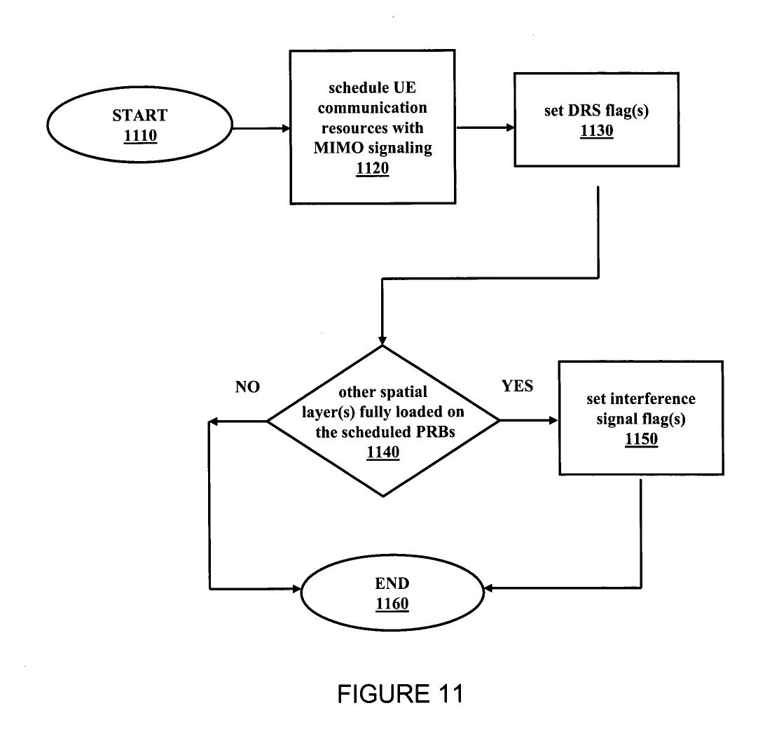

Turning now to FIG. 11, illustrated is a flow chart demonstrating an exemplary process to reduce interference between a plurality of user equipment employing MIMO operation on assigned spatial layers according to the principles of the present invention. The process begins in a module or step (hereinafter “module”) 1110 at a base station. In a module 1120, the base station schedules communication resources to user equipment (“UE”) with MIMO signaling. In a module 1130, the dedicated reference signal index (or flag(s) or bit(s)) are set. In a module 1140, the base station determines if other spatial layers are fully loaded on scheduled physical resource blocks (“PRBs”). If other spatial layers are not fully loaded on the scheduled physical resource blocks, then the process ends in a module 1160. Otherwise, if other spatial layers are fully loaded, then in a module 1150, information such as an interference signal flag(s) or bit(s) are set for the user equipment, and the process ends in the module 1160.

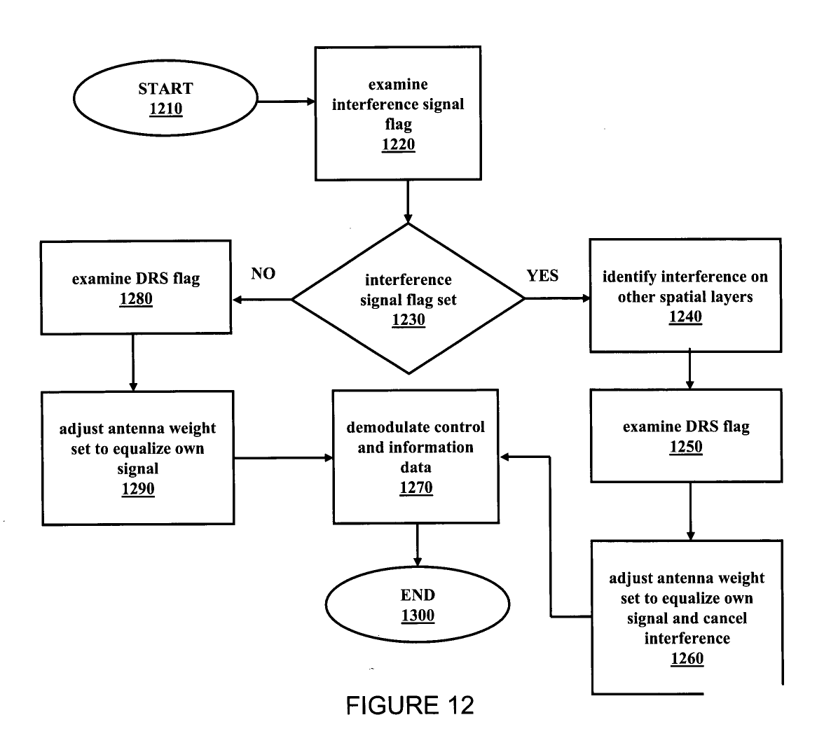

Turning now to FIG. 12, illustrated is a flowchart demonstrating an exemplary process to reduce interference for user equipment employing MIMO operation with another user equipment that may share the same time-frequency communication resources according to the principles of the present invention. The process begins in a module or step (hereinafter “module”) 1210 at user equipment. In a module 1220, the user equipment examines information such as an interference signal flag (or bit(s)). If the interference signal flag is set, as indicated in a module 1230, then in a module 1240, interference on other spatial layers is identified by the user equipment. In a module 1250, the user equipment examines a dedicated reference signal index (flag(s) or bit(s)). Then, in a module 1260, the user equipment adjusts the antenna weight set to equalize its own signal and to cancel interference with another user equipment in accordance with, for instance, the interference signal flag. Then, in a module 1270, the user equipment demodulates control and information data in accordance with, for instance, the dedicated reference signal index. The process then ends in a module 1300.

However, if the user equipment determines that the interference signal flag was not set, then, in a module 1280 the user equipment examines the dedicated reference signal (“DRS”) index. Then, in a module 1290, the user equipment adjusts an antenna weight set to equalize its own signal and proceeds as described above, in the module 1270, to demodulate control and information data, and the process ends in the module 1300.

Thus, as introduced herein, reliable dedicated reference signal-based interference estimation is enabled and performed for (single-cell/multi-cell) MU-MIMO operation with quite low overhead. Interference estimation enables interference cancellation, and the performance of MU-MIMO operation is accordingly improved. In one embodiment, an apparatus (e.g., a base station) employing MIMO operation in a communication system includes a processor (via, for instance, a resource allocator) configured to provide an interference signal flag (e.g., a bit or bits) for a downlink control signal to signal a user equipment to execute a process to detect interference from an interfering user equipment. The interference signal flag is associated with a dedicated reference signal set of the interfering user equipment. The processor (via, for instance, a resource allocator) is configured to set the interference signal flag if the communication resource allocation of the interfering user equipment overlaps or fully overlaps with the communication resource allocation of the user equipment. The processor (via, for instance, a resource allocator) also is configured to produce a dedicated reference signal flag (e.g., a bit or bits) for an index to the dedicated reference signal set that enables the user equipment to demodulate control and data signals transmitted by the base station to the user equipment. The communication system employing the base station may be operable according to 3GPP LTE standards.

In another embodiment, an apparatus (e.g., user equipment) employing MIMO operation in a communication system includes a processor (via, for instance, a resource allocator) configured to initiate an interference cancellation process to reduce interference from an interfering user equipment upon receipt of an interference signal flag (e.g., bit or bits) transmitted by a base station. For instance, the interference cancellation process may produce an antenna weighting set for a plurality of receiving antennas to reduce the interference from the interfering user equipment. Alternatively, the interference cancellation process may increase a signal-to-interference ratio of a signal received by the user equipment from the base station. The processor (via, for instance, a resource allocator) is configured to respond to a dedicated reference signal flag (e.g., bit or bits) that indexes a dedicated reference signal set that enables the user equipment to demodulate control and data signals transmitted by the base station to the user equipment. The communication system employing the user equipment may be operable according to 3GPP LTE standards.

The apparatus and associated method or process for the communication system is applicable, without limitation, to both single-cell and multi-cell MU-MIMO operation. Although the apparatus and method described herein have been described with respect to orthogonal frequency division multiplex access (“OFDMA”)-based communication systems, the apparatus and method are equally applicable to other types of communication systems.

Program or code segments making up the various embodiments of the present invention may be stored in a computer readable medium or transmitted by a computer data signal embodied in a carrier wave, or a signal modulated by a carrier, over a transmission medium. For instance, a computer program product including a program code stored in a computer readable medium may form various embodiments of the present invention. The “computer readable medium” may include any medium that can store or transfer information. Examples of the computer readable medium include an electronic circuit, a semiconductor memory device, a read only memory (“ROM”), a flash memory, an erasable ROM (“EROM”), a floppy diskette, a compact disk

(“CD”)-ROM, an optical disk, a hard disk, a fiber optic medium, a radio frequency (“RF”) link, and the like. The computer data signal may include any signal that can propagate over a transmission medium such as electronic communication network channels, optical fibers, air, electromagnetic links, RF links, and the like. The code segments may be downloaded via computer networks such as the Internet, Intranet, and the like.

As described above, the exemplary embodiment provides both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. Also, many of the features, functions and steps of operating the same may be reordered, omitted, added, etc., and still fall within the broad scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1-30. (canceled)

31. An apparatus, comprising:
a processor; and
memory including computer program code
said memory and said computer program code configured to, with said processor, cause said apparatus to perform at least the following:
allocate communication resources in a spatial layer to a user equipment,
provide a dedicated reference signal index for said user equipment, and
provide information about spatial interference for said user equipment if at least one communication resource within said communication resources allocated to said user equipment is allocated in another spatial layer.

32. The apparatus as recited in claim 31 wherein said at least one communication resource within said communication resources allocated to said user equipment is allocated to another user equipment in said another spatial layer.

33. The apparatus as recited in claim 31 wherein said information about said spatial interference comprises an interference signal flag.

34. The apparatus as recited in claim 31 wherein said information about said spatial interference comprises information configured to enable said user equipment to substantially cancel said spatial interference.

35. The apparatus as recited in claim 31 wherein said dedicated reference signal index comprises information configured to enable said user equipment to demodulate data signals thereto.

36. A computer program product comprising a program code stored in a computer readable medium configured to:
allocate communication resources in a spatial layer to a user equipment,
provide a dedicated reference signal index for said user equipment, and
provide information about spatial interference for said user equipment if at least one communication resource within said communication resources allocated to said user equipment is allocated in another spatial layer.

37. A method, comprising:
allocating communication resources in a spatial layer to a user equipment,
providing a dedicated reference signal index for said user equipment, and
providing information about spatial interference for said user equipment if at least one communication resource within said communication resources allocated to said user equipment is allocated in another spatial layer.

38. The method as recited in claim 37 wherein said at least one communication resource within said communication resources allocated to said user equipment is allocated to another user equipment in said another spatial layer.

39. The method as recited in claim 37 wherein said information about said spatial interference comprises an interference signal flag.

40. The method as recited in claim 37 wherein said information about said spatial interference comprises information configured to enable said user equipment to substantially cancel said spatial interference.

41. An apparatus, comprising:
a processor; and
memory including computer program code
said memory and said computer program code configured to, with said processor, cause said apparatus to perform at least the following:
receive an allocation of communication resources and a dedicated reference signal index for a spatial layer associated with said communication resources;
receive information about spatial interference for a user equipment; and
identify spatial interference with respect to at least one communication resource within said communication resources allocated to said user equipment in another spatial layer.

42. The apparatus as recited in claim 41 wherein said at least one communication resource within said communication resources is allocated to another user equipment in said another spatial layer.

43. The apparatus as recited in claim 41 wherein said information about said spatial interference comprises an interference signal flag.

44. The apparatus as recited in claim 41 wherein said memory and said computer program code is configured to, with said processor, cause said apparatus to substantially cancel said spatial interference.

45. The apparatus as recited in claim 41 wherein said memory and said computer program code is configured to, with said processor, cause said apparatus to demodulate data signals to said user equipment in accordance with said dedicated reference signal index.

46. The apparatus as recited in claim 41 wherein said memory and said computer program code is configured to, with said processor, cause said apparatus to receive said information about said spatial interference over a physical downlink control channel.

47. A computer program product comprising a program code stored in a computer readable medium configured to:
receive an allocation of communication resources and a dedicated reference signal index for a spatial layer associated with said communication resources;
receive information about spatial interference for a user equipment; and
identify spatial interference with respect to at least one communication resource within said communication resources allocated to said user equipment in another spatial layer.

48. A method, comprising:
receiving an allocation of communication resources and a dedicated reference signal index for a spatial layer associated with said communication resources;
receiving information about spatial interference for a user equipment; and
identifying spatial interference with respect to at least one communication resource within said communication resources allocated to said user equipment in another spatial layer.

49. The method as recited in claim 48 wherein said at least one communication resource within said communication resources is allocated to another user equipment in said another spatial layer.

50. The method as recited in claim 48 wherein said information about said spatial interference comprises an interference signal flag.

51. The method as recited in claim 48 further comprising substantially canceling said spatial interference.
